(19) United States
(12) Patent Application Publication
(10) Pub. No.: US 2005/0074010 A1
(43) Pub. Date: Apr. 7, 2005

(54) Method and apparatus for exchanging routing information in distributed router system

(76) Inventors: Kil-Lyeon Kim, Suwon-city (KR); Byung-Gu Choe, Seoul (KR)

Correspondence Address: Robert E. Bushnell, Suite 300, 1522 K Street, N.W., Washington, DC, 20005, US

(21) Appl. No.: 10/778,347

(22) Filed: Feb. 17, 2004

(30) Foreign Application Priority Data
Feb. 18, 2003 (KR) 2003-10190

(51) Int. Cl. H04L 12/28

(52) U.S. Cl. 370/394

(57) ABSTRACT

A method and apparatus for exchanging routing information in a distributed router system provide enhanced reliability of routing information exchanged between routing processors. To exchange routing information between routing processors in a distributed router system, a transceiving unit adds a header, including a sequence number, to update information transmitted from the routing protocol daemon, and multicasts the update information to another peer. A control unit transmits a sequential update packet, provided by a peer, to the transceiving unit, and a continuous update packet is stored in a receiver buffer for the routing protocol daemon. The control unit then stores in the receiver buffer a non-sequential update packet provided by another peer to the transceiving unit, in the receiver buffer, receives a synchronous signal from another peer, and releases the sender buffer. Subsequently, the control unit receives a maximum value, requests the retransmission of a lost packet, and transmits the maximum value and the synchronous signal periodically. Finally, if a retransmission request signal is received from another peer through the transceiving unit, the lost packet is read from the sender buffer, and is retransmitted through the transceiving unit.

### CLAIM OF PRIORITY

This application makes reference to, incorporates the same herein, and claims all benefits accruing under 35 U.S.C. §119 from my application METHOD AND APPARATUS FOR EXCHANGING ROUTING INFORMATION IN DISTRIBUTED ROUTER filed with the Korean Industrial Property Office on Feb. 18, 2003 and there duly assigned Serial No. 2003-10190.

### BACKGROUND OF INVENTION

1. Technical Field

The present invention generally relates to a distributed router system and, more particularly, to a method and apparatus for exchanging routing information in a distributed router system while providing enhanced reliability of routing information exchanged between routing processors.

2. Related Art

In general, a router consists of 4 components: an input port, an output port, a switching fabric, and a routing processor.

The input port is in contact with a physical link and is a gateway for receiving packets. The switching fabric internally connects the input port to the output port. The output port stores packets and schedules for sending the packets to an output link.

Lastly, the routing processor processes a routing protocol, and generates a forwarding table for used in packet forwarding.

In the case wherein a routing function is implemented by software running in a processing environment, if processing performance of the software is not as fast as an input packet speed, a bottleneck phenomenon occurs. In addition, in a routing process, a packet forwarding part for adding new header information to an input packet and resending it is dependent on traffic flow rate.

As Internet traffic has exponentially increased in recent years, manufacturers have now introduced a distributed router system with an appropriate distributed structure for handling the increased traffic.

In addition, to realize a high-speed routing function, manufacturers are developing high-speed forwarding engine techniques for which the packet forwarding part is separated.

In light of the general tendency of a system structure, a distributed structure, in which forwarding engines are distributively disposed at respective line connection units, is preferred to a server type structure, in which a forwarding engine unit is shared with others.

The distributed router system performs a routing function and a packet forwarding function in different processors.

The distributed router system of the related art is composed of physical connection units for data input/output, routing processors for performing routing and packet forwarding functions, a switching unit for exchanging routing information between routing processors and for providing a connection bus, and a backup switching unit for redundancy.

Upon receiving a packet, the routing processors search the routing tables in order to forward the packet to a gateway corresponding to a destination address of the packet.

For example, when a packet with a destination address of 200.1.1.1 is received by the routing processor through the physical connection unit, the routing processor searches a routing table.

What actually results from searching the routing table is a gateway address that corresponds to the destination address 200.1.1.1. Therefore, the packet is switched at the switching unit, and forwarded to the physical connection unit through the routing processor.

In the distributed router system, each of the routing processors is an independent router, and thus can give a routing protocol deamon, e.g., BGP (Border Gateway Protocol), OSPF (Open Shortest Path First Protocol), RIP (Routing Information Protocol) and so forth, respectively, and exchanges routing information with neighboring routing processors by making a peering with them.

However, in the above case, where a plurality of routing processors are operated under one router system, it is very important for each of the routing processors to be able to maintain routing information consistency.

Therefore, a routing processor receives routing information through a peer of the routing processor or another path, and transmits the information to the other routing processors of the distributed router system.

This transmission mechanism should be based on reliability and, on the other hand, data transmission quantity should be cut to reduce a load on the distributed router system.

Typically used methods for routing information transmission between routing processors involve utilizing TCP (Transmission Control Protocol), broadcasting or multicasting.

Each of the routing processors exchanges information through the TCP connected between routing processors.

Suppose that there are n routing processors. Each of the routing processors sets a TCP connection with the other n−1 routing processors, respectively, and sends routing information n−1 times through the TCP connections.

The broadcasting or multicasting methods utilize UDP (User Datagram Protocol) or IP raw socket, and transmit routing information to many routing processors at once.

Considering the nature of UDP or IP, the above methods cannot guarantee that information is sent to all of the routing processors, and the transmitting side does not know which routing processor has not received the information.

More specifically, despite the high reliability of information transmission, the routing information transmission between routing processors using TCP is disadvantageous in that n*(n−1)/2 TCP connections are necessary to maintain TCP connections between each of the routing processors, consequently increasing traffic in the distributed router system and increasing overhead in each of the routing processors having (n−1) TCP connections. Moreover, because the same packet is transmitted over and over, the internal traffic of the distributed router system is also increased.

The multicasting and broadcasting methods are effective, compared with the above method, but the reliability of each is not satisfactory.

Briefly, the problem with data transmission of the related art is that the same information was not always sent to all the routing processors. Hence, it was very difficult to maintain the consistency of routing information throughout the entire distributed router system.

The following patents are considered to be generally pertinent to the present invention, but are burdened by the disadvantages set forth above: U.S. Pat. No. 6,501,741 to Mikkonen et al., entitled METHOD SUPPORTING THE QUALITY OF SERVICE OF DATA TRANSMISSION, issued on Dec. 31, 2002; U.S. Pat. No. 5,999,518 to Nattkemper et al., entitled DISTRIBUTED TELECOMMUNICATIONS SWITCHING SYSTEM AND METHOD, issued on Dec. 7, 1999; U.S. Pat. No. 5,953,318 to Nattkemper et al., entitled DISTRIBUTED TELECOMMUNICATIONS SWITCHING SYSTEM AND METHOD, issued on Sep. 14, 1999; U.S. Pat. No. 5,805,816 to Picazo Jr. et al., entitled NETWORK PACKET SWITCH USING SHARED MEMORY FOR REPEATING AND BRIDGING PACKETS AT MEDIA RATE, issued on Sep. 8, 1998; U.S. Pat. No. 5,771,349 to Picazo Jr. et al., entitled NETWORK PACKET SWITCH USING SHARED MEMORY FOR REPEATING AND BRIDGING PACKETS AT MEDIA RATE, issued on Jun. 23, 1998; U.S. Pat. No. 5,742,760 to Picazo Jr. et al., entitled NETWORK PACKET SWITCH USING SHARED MEMORY FOR REPEATING AND BRIDGING PACKETS AT MEDIA RATE, issued on Apr. 21, 1998; U.S. Pat. No. 5,737,525 to Picazo Jr. et al., entitled NETWORK PACKET SWITCH USING SHARED MEMORY FOR REPEATING AND BRIDGING PACKETS AT MEDIA RATE, issued on Apr. 7, 1998; U.S. Pat. No. 5,720,032 to Picazo Jr. et al., entitled NETWORK PACKET SWITCH USING SHARED MEMORY FOR REPEATING AND BRIDGING PACKETS AT MEDIA RATE, issued on Feb. 17, 1998; U.S. Pat. No. 6,553,030 to Ku et al., entitled TECHNIQUE FOR FORWARDING MULTI-CAST DATA PACKETS, issued on Apr. 22, 2003; U.S. Pat. No. 6,532,088 to Dantu et al., entitled SYSTEM AND METHOD FOR PACKET LEVEL DISTRIBUTED ROUTING IN FIBER OPTIC RINGS, issued on Mar. 11, 2003; U.S. Pat. No. 6,466,578 to Mauger et al., entitled SCALEABLE DATA NETWORK ROUTER, issued on Oct. 15, 2002; U.S. Pat. No. 6,618,372 to Tanabe et al., entitled PACKET SWITCHING SYSTEM HAVING HAVING SELF-ROUTING SWITCHES, issued on Sep. 9, 2003; U.S. Pat. No. 6,611,519 to Howe, entitled LAYER ONE SWITCHING IN A PACKET, CELL, OR FRAME-BASED NETWORK, issued on Aug. 26, 2003; U.S. Pat. No. 6,606,326 to Herring, entitled PACKET SWITCH EMPLOYING DYNAMIC TRANSFER OF DATA PACKET FROM CENTRAL SHARED QUEUE PATH TO CROSS-POINT SWITCHING MATRIX PATH, issued on Aug. 12, 2003; U.S. Pat. No. 6,594,268 to Aukia et al., entitled ADAPTIVE ROUTING SYSTEM AND METHOD FOR QOS PACKET NETWORKS, issued on Jul. 15, 2003; U.S. Pat. No. 6,584,101 to Hagglund et al., entitled COMMUNICATION METHOD FOR PACKET SWITCHING SYSTEMS, issued on Jun. 24, 2003; U.S. Pat. No. 6,584,071 to Kodialam et al., entitled ROUTING WITH SERVICE LEVEL GUARANTEES BETWEEN INGRESS-EGRESS POINTS IN A PACKET NETWORK, issued on Jun. 24, 2003; U.S. Pat. No. 6,577,635 to Narayana et al., entitled DATA PACKET TRANSMISSION SCHEDULING, issued on Jun. 10, 2003; U.S. Pat. No. 6,574,240 to Tzeng, entitled APPARATUS AND METHOD FOR IMPLEMENTING DISTRIBUTED LAYER 3 LEARNING IN A NETWORK SWITCH, issued on Jun. 3, 2003; U.S. Pat. No. 6,560,229 to Kadambi et al., entitled NETWORK SWITCHING ARCHITECTURE WITH MULTIPLE TABLE SYNCHRONIZATION, AND FORWARDING OF BOTH IP AND IPX PACKETS, issued on May 6, 2003; and U.S. Pat. No. 6,512,745 to Abe et al., entitled PACKET SWITCHING NETWORK, PACKET SWITCHING EQUIPMENT, AND NETWORK MANAGEMENT EQUIPMENT, issued on Jan. 28, 2003.

### SUMMARY OF THE INVENTION

An object of the invention is to solve at least the above problems and/or disadvantages, and to provide at least the advantages described hereinafter.

Accordingly, one object of the present invention is to solve the foregoing problems by providing a method and apparatus for exchanging routing information in a distributed router system, with enhanced reliability of routing information exchange between routing processors.

The foregoing and other objects and advantages are realized by providing an apparatus for exchanging routing information in a distributed router system, the apparatus including: an initiating module for performing an initiation process when a routing protocol daemon is operated; a transceiving unit for allocating a sequence number to update information transmitted from the routing protocol daemon, for adding a header including the allocated sequence number to the update information, for multicasting the update information to a peer (another internal routing processor), and for receiving the packet from another peer; a buffer for storing the transmitted update packet to the peer and a non-sequential update packet received from another peer; and a control unit which responds to the transceiving unit receiving a sequential update packet from a peer by sending a received sequential update packet and a continuous update packet stored in the buffer to the routing protocol daemon, and which responds to the transceiving unit receiving a non-sequential packet from a peer by storing the packet in the buffer, receiving a synchronous signal from a peer and releasing the buffer, receiving a maximum value and requesting the retransmission of a lost packet, transmitting a synchronous signal and a maximum value periodically, and, if a retransmission request signal is received from a peer through the transceiving unit, reading a lost packet from the buffer and retransmitting the lost packet through the transceiving unit.

Another aspect of the present invention provides a method for exchanging routing information in a distributed router system, the method including: a first step, at an initiating unit, for performing an initiation process when a routing protocol demon is in operation; a second step, at a transceiving unit, for adding a header including a sequence number to update information transmitted from the routing protocol daemon and for multicasting the update information to another peer; a third step, at a control unit, for transmitting a sequential update packet provided by a peer to the transceiving unit, a continuous update packet being stored in a receiver buffer for the routing protocol daemon; a fourth step, at the control unit, for storing a non-sequential update packet provided by another peer to the transceiving unit in the receiver buffer; a fifth step, at the control unit, for receiving a synchronous signal from another peer and releasing the sender buffer; a sixth step, at the control unit, for receiving a maximum value and requesting the retransmission of a lost packet, and for transmitting the maximum value and the synchronous signal periodically; and a seventh step for reading the lost packet out of the sender buffer if a retransmission request signal is received from another peer through the transceiving unit, and for retransmitting the lost packet through the transceiving unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an explanatory diagram of a configuration of a routing entry in a distributed router system of the related art;

FIG. 2 is a diagram illustrating an internal configuration of a reliable apparatus for exchanging routing information between routing processors according to one embodiment of the present invention;

FIG. 3 is a diagram showing internal configurations of a routing processor of the sending side and a routing processor of the receiving side in the reliable apparatus for exchanging routing information according to one embodiment of the present invention;

FIG. 4 is a diagram depicting a stack structure of an RMTRDR (Reliable Multicast Transport Protocol for DR) for use in a distributed router of the present invention;

FIG. 5 is a diagram illustrating a message header format of the RMTPDR for the distributed router of the present invention;

FIG. 6 is a signal flow chart illustrating an initiation procedure according to one embodiment of the present invention;

FIG. 7 is a flow chart illustrating a procedure for transmitting update routing information according to one embodiment of the present invention;

FIG. 8 is a flow chart showing a procedure for processing control signals received from a control module according to one embodiment of the present invention;

FIG. 9 is a flow chart showing a retransmission procedure according to one embodiment of the present invention;

FIG. 10 is a flow chart showing a procedure for transmitting a maximum value according to one embodiment of the present invention;

FIG. 11 is a flow chart showing a procedure for managing a sender buffer according to one embodiment of the present invention;

FIG. 12 is a flow chart showing a procedure for receiving and processing update routing information according to one embodiment of the present invention;

FIG. 13 is a flow chart showing a procedure for retransmission process according to one embodiment of the present invention;

FIG. 14 is a flow chart showing a procedure for processing a maximum value according to one embodiment of the present invention;

FIG. 15 is a flow chart showing a procedure for sending synchronous signals according to one embodiment of the present invention; and

FIG. 16 is a flow chart showing a procedure for managing a receiver buffer according to one embodiment of the present invention.

### DETAILED DESCRIPTION OF EXEMPLARY EMBODIMENTS

Reference will now be made in detail to exemplary embodiments of the present invention, which are illustrated in the accompanying drawings.

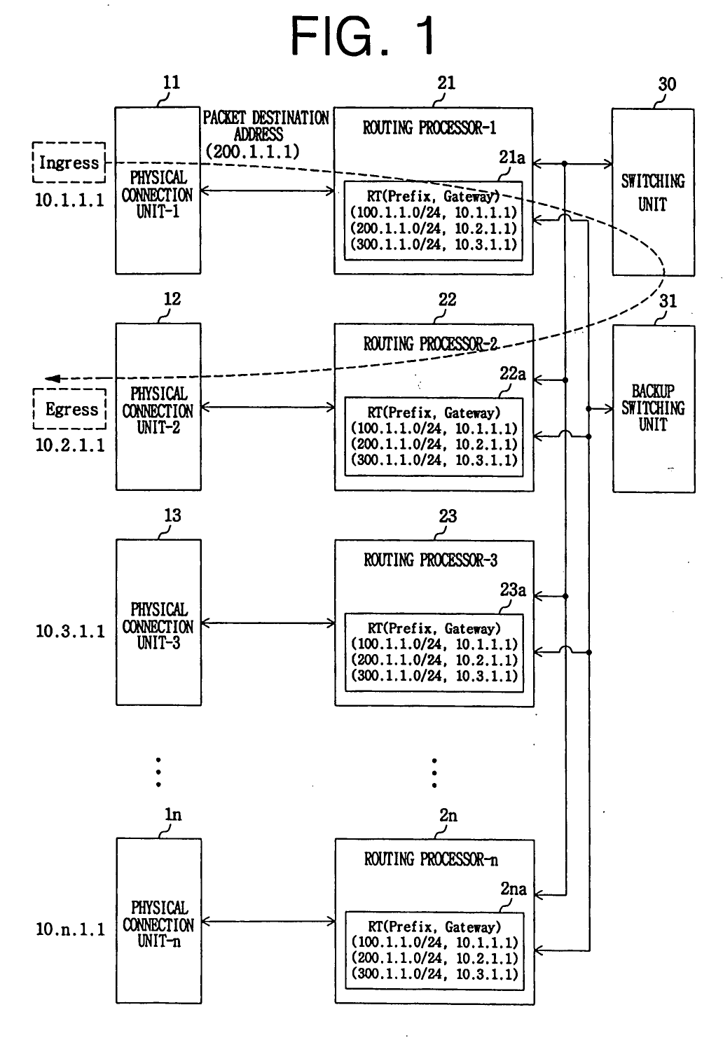

FIG. 1 is an explanatory diagram of a configuration of a routing entry in a distributed router system of the related art.

As depicted in the drawing, the distributed router system of the related art is composed of physical connection units 11˜1n for data input/output, routing processors 21˜2n for performing routing and packet forwarding functions, a switching unit 30 for exchanging routing information between routing processor 21˜2n and for providing a connection bus, and a backup switching unit 31 for redundancy.

Upon receiving a packet, the routing processors 21˜2n search the routing tables 21a˜2na, to forward the packet to a gateway corresponding to a destination address of the packet.

For example, when a packet with a destination address 200.1.1.1 is received by the routing processor 21 through the physical connection unit 11, the routing processor 21 searches a routing table 21a.

What actually resulted from a search of the routing table 21a is a gateway address (in this case, 10.2.1.1) that corresponds to the destination address 200.1.1.1. Therefore, the packet is switched at the switching unit 30, and forwarded to the physical connection unit 12 through the routing processor 22.

In the distributed router system with the configuration shown in FIG. 1, each of the routing processors 21˜2n is an independent router, and thus can give a routing protocol deamon, e.g., BGP (Border Gateway Protocol), OSPF (Open Shortest Path First Protocol), RIP (Routing Information Protocol) and so forth, respectively, and exchange routing information with neighboring routing processor 21˜2n by making a peering with them.

However, in the above case, when a plurality of routing processors 21˜2n are operated under one router system, it is very important for each of the routing processors 21˜2n to be able to maintain routing information consistency.

Therefore, a routing processor 21˜2n receives routing information through a peer of the routing processor 21˜2n or another path, and transmits the information to the other routing processors 21˜2n of the distributed router system.

This transmission mechanism should be based on reliability, and on the other hand, data transmission quantity should be cut to reduce a load on the distributed router system.

Typically used methods for routing information transmission between routing processors 21˜2n are utilizing TCP (Transmission Control Protocol), broadcasting or multicasting.

Each of the routing processor 21˜2n exchanges information through the TCP connected between routing processors.

Suppose that there are n routing processors 21˜2n. Each of the routing processors 21˜2n sets a TCP connection with the other n−1 routing processors 21˜2n, respectively, and sends routing information n−1 times through the TCP connections.

The broadcasting or multicasting methods utilize UDP (User Datagram Protocol) or IP raw socket, and transmit routing information to many routing processors 21˜2n at once.

Considering the nature of UDP or IP, the above methods cannot guarantee that information is sent to all of the routing processors 21˜2n, and the transmitting side does not know which routing processor 21˜2n has not received the information.

More specifically, despite the high reliability of information transmission, the routing information transmission between routing processors 21˜2n using TCP is disadvantageous in that n*(n−1)/2 TCP connections are necessary to maintain TCP connections between each of the routing processors 21˜2n, consequently increasing traffic in the distributed router system and increasing overhead in each of the routing processors having (n−1) TCP connections. Moreover, because the same packet is transmitted over and over, the internal traffic of the distributed router system is also increased.

The multicasting and broadcasting methods are effective, compared with the above method, but the reliability of each is not satisfactory.

In short, the problem with data transmission of the related art is that the same information was not always sent to all the routing processors 21˜2n. Hence, it was very difficult to maintain the consistency of routing information throughout the entire distributed router system.

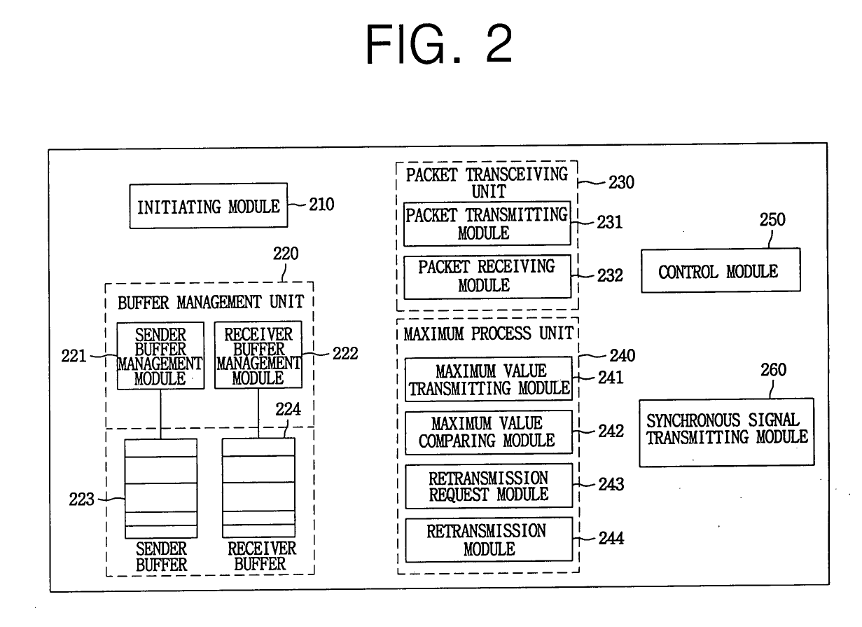

FIG. 2 is a diagram illustrating an internal configuration of a reliable apparatus for exchanging routing information between routing processors according to one embodiment of the present invention.

As depicted in FIG. 2, the reliable apparatus for exchanging routing information between routing processors includes an initiating module 210, a buffer managing unit 220, a packet transceiving unit 230, a maximum value processing unit 240, a control module 250, and a synchronous signal transmitting module 260.

The buffer managing unit 220 includes a sender buffer management module 221, a receiver buffer management module 222, a sender buffer 223, and a receiver buffer 224.

The packet transceiving unit 230 includes a packet transmitting module 233 and a packet receiving module 232, and the maximum value processing unit 240 includes a maximum value transmitting module 241, a maximum value comparing module 242, a retransmission request module 243, and a retransmission module 244.

The control module 250 defines a buffer structure (or buffer architecture) for managing the sender buffer 223 and the receiver buffer 224, and stores the buffer structure in a memory. The buffer structure, as shown in Table 1 below, is a data structure for defining the sender buffer 223 and the receiver buffer 224.

TABLE 1

| Type | Name | Definition |
|---|---|---|
| struct | next | This is a next packet buffer's |
| RMTP_PACKET_BUFFER* | | point. |
| struct | prev | This is a previous packet |
| RMTP_PACKET_BUFFER* | | buffer's point. |
| struct stream* | s | This is a data buffer's point. |
| u_int32_t | seq | This is a packet sequence |
| | | number. |

The control module 250 determines a transceiving status of routing information, defines a data structure of the transceiving status, and stores the data structure in the memory for use in data transceiving. The data structure of the transceiving status is provided below (Table 2).

TABLE 2

| Type | Name | Definition |
|---|---|---|
| struct PEER_STATUS | next | This is a point of a next peer's status |
| | | structure. |
| in_addr | peer_ip | This is a peer's IP address. |
| u_int32_t | adv_seq | This is a last sequence number |
| | | transmitted from a |
| | | peer. |
| u_int32_t | rcv_nxt | This is a next sequence number to be |
| | | sent from a peer. |
| u_int32_t | rcv_max | This is a sequence number of a last |
| | | packet from a peer. |
| u_int32_t | max_sent | This is a maximum value sent from a |
| | | peer. |
| u_int32_t | reassem_count | This is the number of packets in a |
| | | reassemble. |
| struct | reassem_buffer | This is a pointer indicating a first |
| RMTP_PACKET_BUFFER* | | packet in a reassemble buffer. |
| structNACK_record* | nack_list | This is a list of sequence numbers of |
| | | packets to be retransmitted. |

Moreover, the control module 250 defines a data structure of a peer status for transceiving routing information. The data structure of the peer status is illustrated below (Table 3).

TABLE 3

| Type | Name | Definition |
|---|---|---|
| struct | sent_buffer | This is a point indicating a first packet |
| RMTP_PACKET_BUFFER* | | of the sender buffer. |
| struct | sent_buffer_last | This is a point indicating a last packet |
| RMTP_PACKET_BUFFER* | | of the sender buffer. |
| u_int32_t | snd_una | This is a sequence number of a first |
| | | packet that has not received a receive |
| | | complete signal. |
| u_int32_t | snd_nxt | This is a sequence number of a next |
| | | packet. |
| int | sent_count | This is the number of update packets |
| | | that are sent. |
| int | sent_last | This is a sequence number of a last |
| | | packet being sent. |
| int | nack_count | This is the number of packets to be |
| | | retransmitted. |
| structPEER_STATUS* | peer_list | This is a point indicating a peer |
| | | routing processor list. |
| struct thread* | t_sync | This is a timer thread for transmitting |
| | | synchronous signals. |
| struct thread* | t_max | This is a timer thread for transmitting |
| | | a maximum value. |
| struct thread* | t_write | This is a writing thread for |
| | | transmitting a packet through the net. |
| struct stream_fifo* | abuf_control | This is a FIFO thread of a control |
| | | packet. |
| struct stream_fifo* | aduf_update | This is a FIFO thread of an update |
| | | packet. |

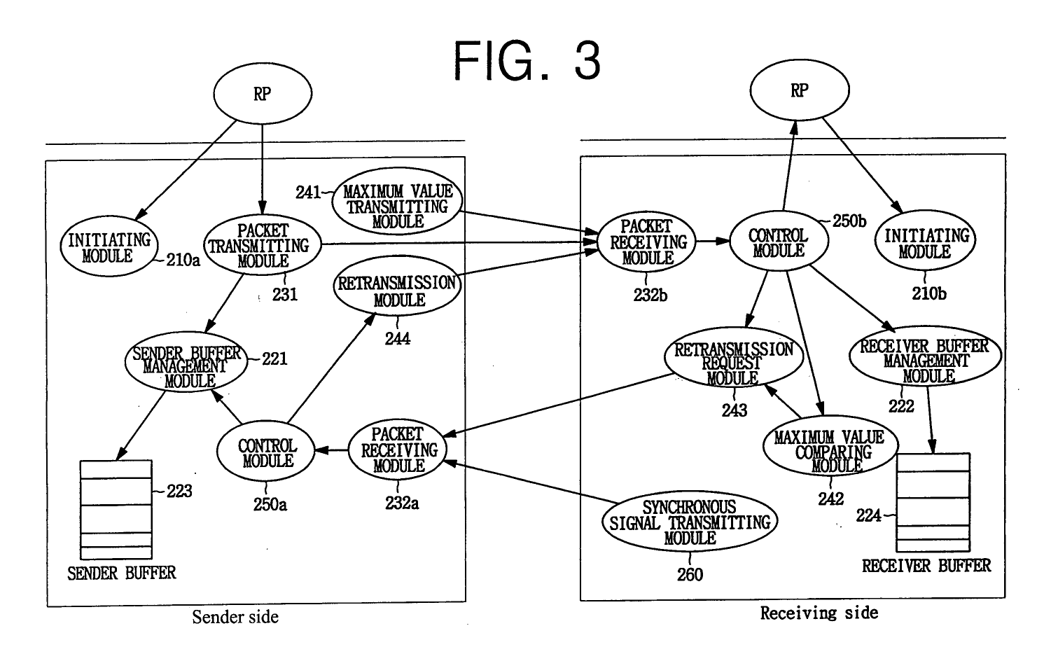

FIG. 3 is a diagram showing internal configurations of a routing processor of the sender side and a routing processor of the receiving side in the reliable apparatus for exchanging routing information according to one embodiment of the present invention. In the drawing, only a necessary configuration for sending routing information is included in the routing processor of the sender side and, in like manner, only a necessary configuration for receiving routing information is included in the routing processor of the receiving side.

As shown in FIG. 3, to explain a method for exchanging routing information between routing processors in accordance with one embodiment of the present invention, the internal configuration for the routing processor of the routing information sender side includes an initiating module 210a, a sender buffer management module 221, a sender buffer 223, a packet transmitting module 231, a packet receiving module 232a, a maximum value transmitting module 241, a retransmission module 244, and a control module 250a.

Also, to explain a method for exchanging routing information between routing processors, the internal configuration for the routing processor of the receiving side includes an initiating module 210b, a receiver buffer management module 222, a receiver buffer 224, a packet receiving module 232b, a maximum value comparing module 242, a retransmission request module 243, and a control module 250b.

When a routing protocol deamon is executed in a routing processor, the initiating module 210a sends a HELLO packet to another routing processor for synchronization, and initializes a data structure for managing a more reliable routing information exchange.

For more reliable transmission, the packet transmitting module 231 grants sequence numbers to routing information that is provided by RPD (Routing Protocol Daemon) to be sent to other routing processors, stores the sequence numbers in the sender buffer 223, and transmits the routing information through an IP raw socket in order of the sequence numbers.

The control module 250a processes control packets, such as, NACK, SYNC and the like, as received from another routing processor through the packet receiving module 232a.

Upon receiving a packet retransmission request from the retransmission request module 243 of the receiving side, the control module 250a sends the sequence number of the requested packet to the retransmission module 244, so as to cause the packet having that sequence number to be retransmitted.

Moreover, the control module 250a provides the sequence numbers that have been periodically sent from the synchronous signal transmitting module 260 of the receiving side to the sender buffer management module 221, whereby the sender buffer management module 221 releases the sender buffer 223.

For synchronization, the maximum value transmitting module 241 transmits a maximum sequence number from the sequence numbers provided from the sender side on a regular basis up to this point in time.

The sender buffer management module 221 temporarily stores sender packets in the sender buffer 223 for a retransmission request of a sender packet, and releases the sender buffer 223 more effectively with the help of control packets, such as SYNC.

On the other hand, the packet receiving module 232b of the routing processor of the receiving side receives a packet from the sending routing processor through a multicasting socket, and transmits the packet to the control module 250b.

If the received packet is routing information, the control module 250b sends the packet to the receiver buffer management module 222 and allows the routing information to be buffered by the receiver buffer 224.

If the received packet is maximum value information, not routing information, the control module 250b sends the packet to the maximum value comparing module 242 where the maximum value is processed.

When the packet receiving module 232b receives a non-sequential packet from the packet, the retransmission request module 243 transmits a NACK control packet, requesting retransmission of any lost packet.

The synchronizing signal transmitting module 260 of the receiving side sends the sequence numbers provided periodically up to that point to the sender side so as to release the sender buffer 223 through the sender buffer management module 221.

The maximum value comparing module 242 compares the maximum value information provided by the sender side with the recent sequence number provided to the receiving side and, if there is any lost packet, causes the retransmission request module 243 to request the sender side to retransmit the lost packet.

Lastly, the sender buffer management module 221 temporarily stores the non-sequential packets, sends them according to priority, and releases the sender buffer 223.

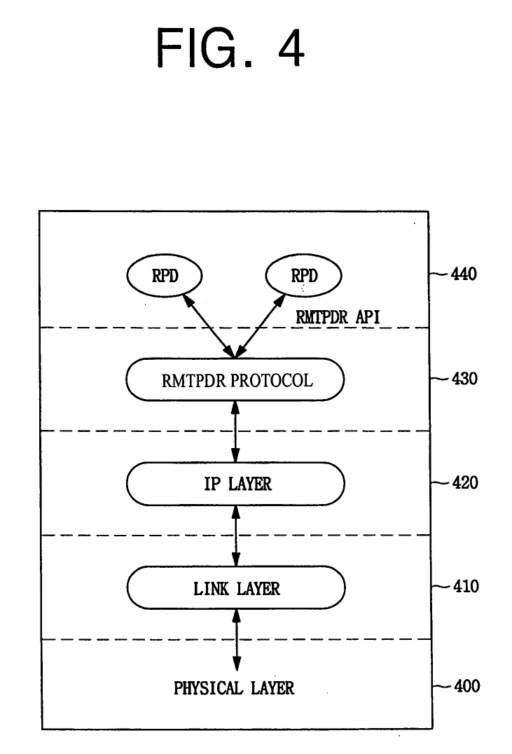

FIG. 4 is a diagram depicting a stack structure of an RMTRDR (Reliable Multicast Transport Protocol for DR) for use in a distributed router system of the present invention.

As shown in FIG. 4, the RPD of the sender side and the RPD of the receiving side send and receive packets through an RMTPDR protocol 430, using an API provided by the RMTPDR protocol 430.

The RMTPDR protocol 430 has a system library format, and provides a transport layer function between an IP layer 420 and an application layer 440.

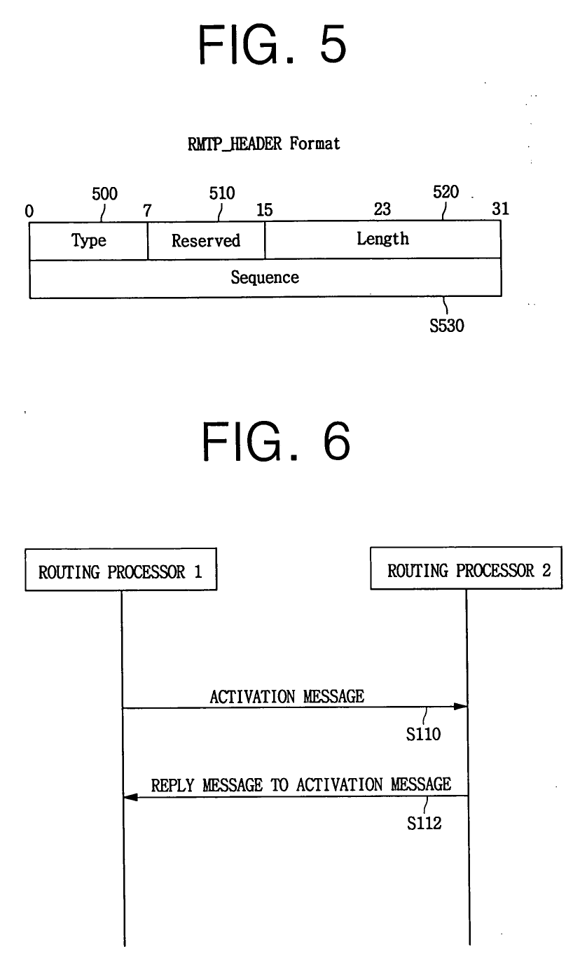

FIG. 5 is a diagram illustrating a message header format of the RMTPDR for the distributed router system of the present invention.

As depicted in FIG. 5, the message header format of the RMTPDR for the distributed router is composed of an 8-bit type field 500, an 8-bit reserved field 510, a 16-bit length field 520, and a sequence field 530 for designating a sequence number.

Kinds of messages to be transmitted are designated in the type field 500, and designated type values are shown below (Table 4).

TABLE 4

| Value | Message | Definition |
|---|---|---|
| 1 | RMTP_MSG_HELLO | This is a message for |
| | | activation. |
| 2 | RMTP_MSG_HELLO_REPLY | This is a replay message to |
| | | an activation signal. |
| 3 | RMTP_MSG_UPDATE | This is a message for update. |
| 4 | RMTP_MSG_SYNC | This is a message for |
| | | synchronous signal |
| | | transmission. |
| 5 | RMTP_MSG_NACK | This is a retransmission |
| | | request message. |
| 6 | RMTP_MSG_MAX | This is a message for a |
| | | maximum value. |

FIG. 6 is a signal flow chart illustrating an initiation procedure according to one embodiment of the present invention.

The initiating module 210 of FIG. 2 allocates a global variable to a routing information transceiving structure for reliable packet transmission using the RMTPDR protocol.

Also, for more reliable data transmission with a routing protocol of another routing processor, the initiating module 210 sends an activation message (RMTP_MSG_HELLO), noticing that a specific RPD of a relevant routing processor has been executed (S110).

Receiving the activation message, the initiating module 210 of anther routing processor sends a sequence number of a next packet, which had been transmitted through its RMTPDR, in a reply message to the activation message for synchronizing the specific RPD (S112).

Receiving the reply message, the initiating module 210 of the routing processor makes a peer status structure in the routing information transceiving structure, in connection with the relevant routing processor, and stores received information.

In addition to the above, the initiating module 210 initiates a synchronous signal transmitting timer and a maximum value transmitting timer for transmission of routing information.

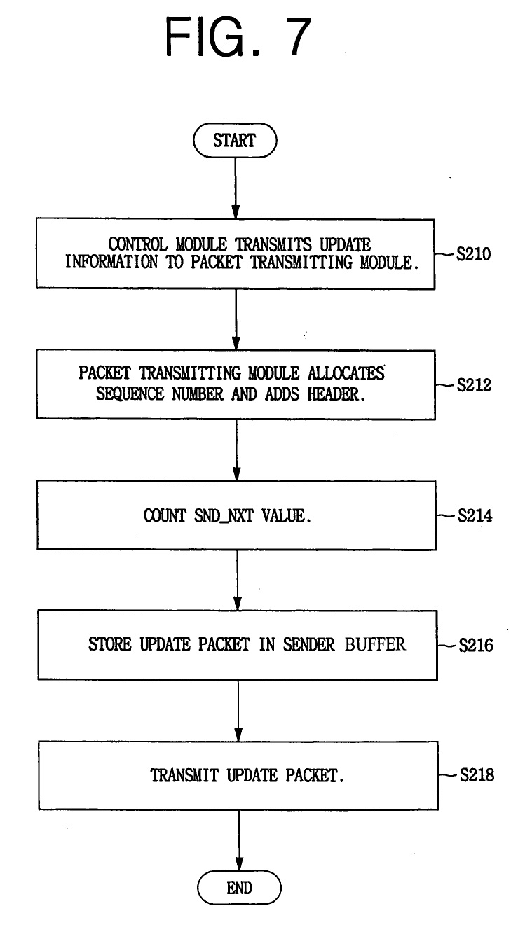

FIG. 7 is a flow chart illustrating a procedure for transmitting update routing information according to one embodiment of the present invention.

As illustrated in FIG. 7, the control module 250a of the sender side sends update information, to be transmitted to another peer (another internal routing processor), to the packet transmitting module 231 (S210).

The packet transmitting module 231 allocates a sequence number to a packet and adds a header (S212), and provides a sequentially increasing integer value to snd_nxt (S214).

The packet transmitting module 231 stores the packets with the sequence number in the sender buffer 223 (S216), and multicasts the packet to each of the routing processors through the IP raw socket (S218).

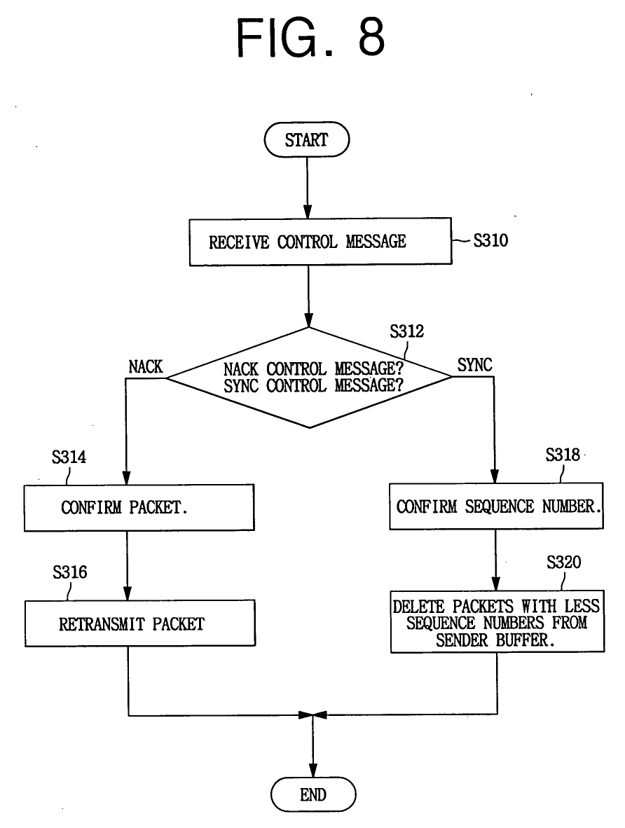

FIG. 8 is a flow chart showing a procedure for processing control signals received from a control module according to one embodiment of the present invention.

As shown in FIG. 8, the control module 250a receives a control message from the receiving side (S310). If the received control message is a NACK control message, requesting the retransmission of a lost packet, control module 250a confirms whether there is a requested packet (S314), and allows the loss packet to be retransmitted through the retransmission module 244 (S316).

On the other hand, if the received message is a SYNC control message, the control module 250a confirms the sequence number in the synchronous signal transmission message (S318), updates snd_una of the transceiving status structure based on the packet information, and releases part of the resources of the sender buffer 223 through the sender buffer management module 221 (S320).

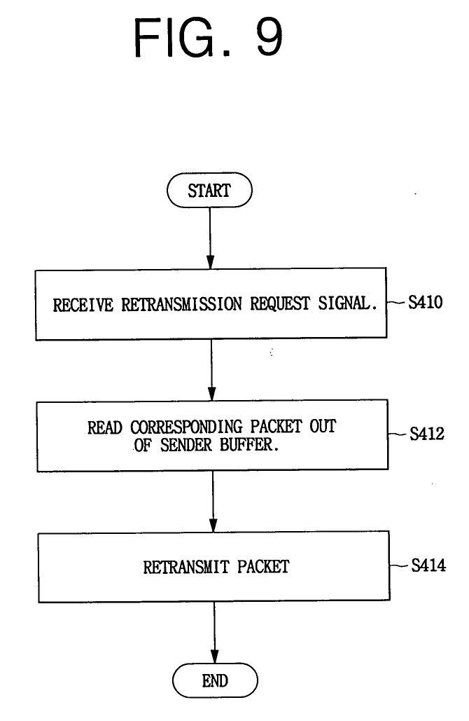

FIG. 9 is a flow chart showing a retransmission procedure according to one embodiment of the present invention.

As shown in FIG. 9, the retransmission module 244 receives a retransmission request from the control module 250a (S410), searches a packet having the requested sequence number from the sender buffer 223 (S412), and retransmits the packet (S414).

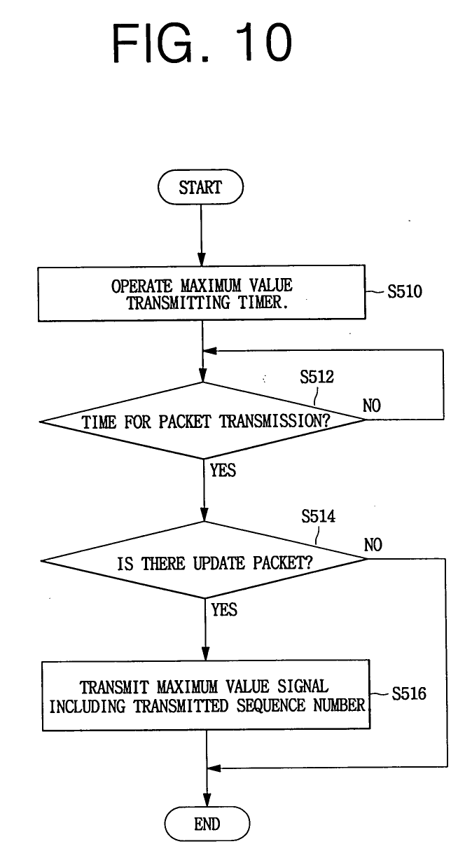

FIG. 10 is a flow chart showing a procedure for transmitting a maximum value according to one embodiment of the present invention.

Referring to FIG. 10, provided that the maximum value transmitting timer is in operation (S510), the maximum value transmitting module 241 determines whether it is time to transmit a packet (S512).

If it is time for transmission, the maximum value transmitting module 241 determines whether an update packet has been sent (S514). If so, it transmits a maximum value message or signal, including all of the sequence numbers of the update packet (S516).

The sender buffer management module 221 temporarily stores routing information sent to a peer in the sender buffer 223 for more reliable information transmission through the RMTPDR protocol and, if necessary, retransmits the routing information.

However, the routing information does not need to be stored in the sender buffer 223 permanently. Once other peers have received the routing information, the routing information is deleted from the sender buffer 223 for the sake of reliability.

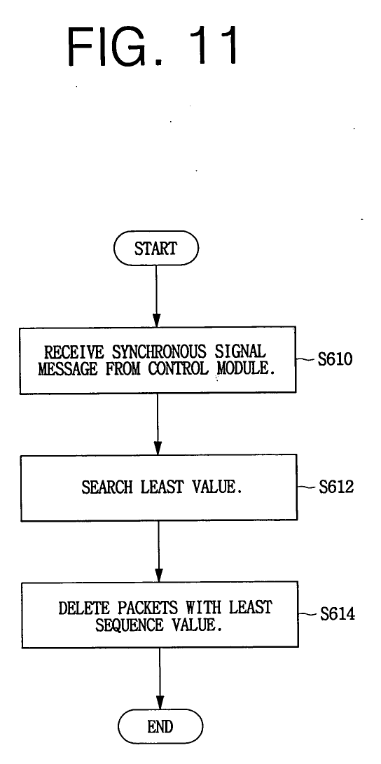

FIG. 11 is a flow chart showing a procedure for managing a sender buffer according to one embodiment of the present invention.

Referring to FIG. 11, the sender buffer management module 221 receives a synchronous signal from the control module 250a (S610), and searches a minimum value (or a minimum sequence number) (S612).

Using the minimum sequence number as a reference, the sender buffer 223 deletes packets having a sequence value equal to or less than the reference, and releases the buffer (S614).

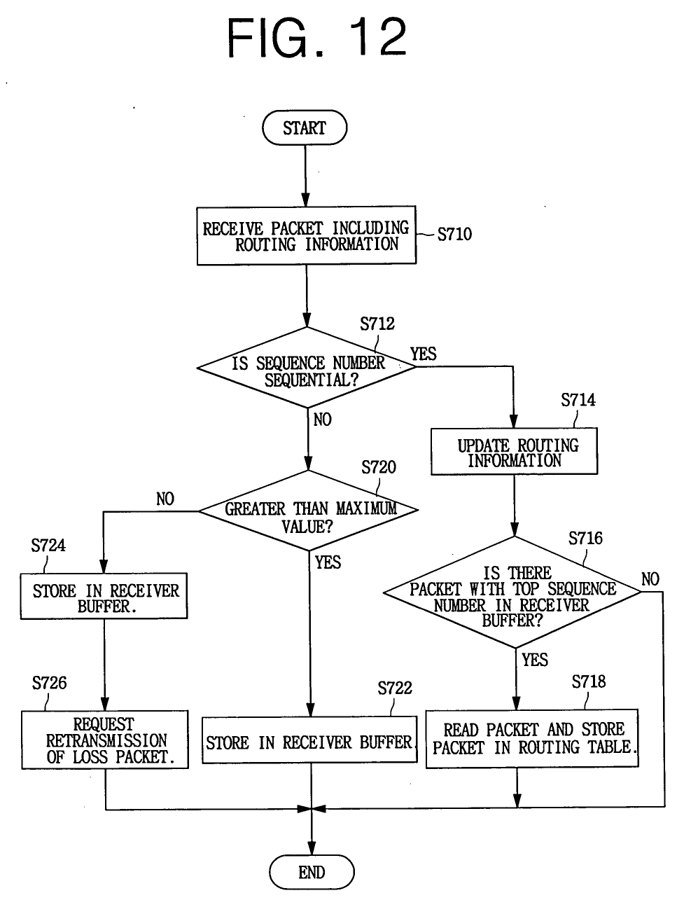

FIG. 12 is a flow chart showing a procedure for receiving and processing update routing information according to one embodiment of the present invention.

As depicted in FIG. 12, the routing processor of the receiving side processes a multicast packet received from the transmitting routing processor by using the packet receiving module 232b, the control module 250b, the maximum value comparing module 242, the retransmission request module 243, and the receiver buffer management module 222.

Upon receiving a packet, including routing information (S710), the control module 250b determines whether the numbers are sequential (S712) and, if they are, stores the packet in a routing table (S714). Then, the control module 250b determines whether there exists a packet having a high sequence number in the receiver buffer (S716) and, if such a packet does exist, control module 250b reads the packet and stores it in the routing table (S718).

If the numbers are not sequential (S712), however, the control module 250b determines whether a certain sequence number is greater than the maximum value (S720). If so, the control module 250b stores the packet in the receiver buffer 224 (S722). If the sequence number is not greater than the maximum value, the control module 250b first stores the packet in the receiver buffer (S724) and, if there is any lost packet, requests retransmission of the lost packet (S726).

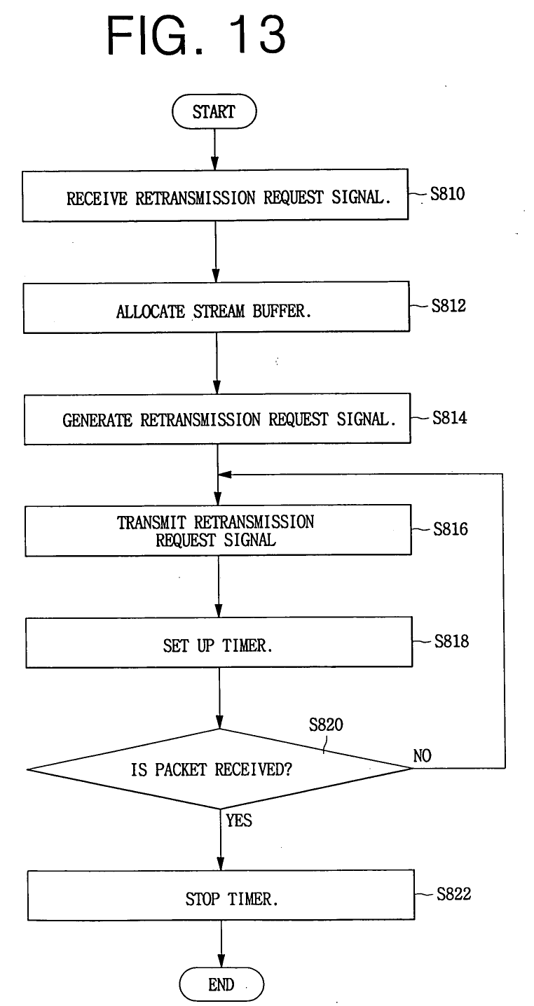

FIG. 13 is a flow chart showing a procedure for a retransmission process according to one embodiment of the present invention.

As shown in FIG. 13, when there is a retransmission request (S810), the retransmission request module 243 allocates a stream buffer (S812), generates a retransmission request signal including a requested sequence number (S814), and transmits the generated retransmission request signal (S816).

According to the requested sequence number, the retransmission module 244 sets the retransmission timer (S818) and, if the sender side retransmits the packet before the timer expires (S820), stops the timer (S822).

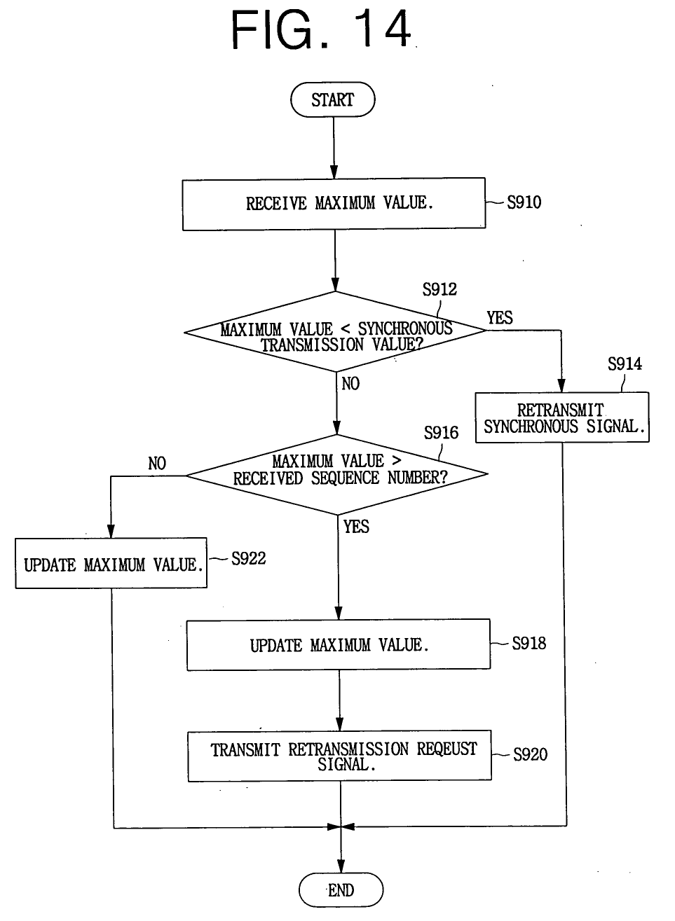

FIG. 14 is a flow chart showing a procedure for processing a maximum value according to one embodiment of the present invention.

Referring to FIG. 14, the maximum value comparing module 242 receives a maximum value (S910), and determines whether the received maximum value is smaller than a synchronous signal transmission value (S912).

If the maximum value is smaller than the synchronous signal transmission value, the maximum value comparing module 242 retransmits a synchronous signal message (S914). If the maximum value is equal to or larger than the synchronous signal transmission value, the maximum value comparing module 242 determines whether the maximum value is larger than the received sequence number (S916).

If the maximum value is equal to or smaller than the received sequence number, the maximum value comparing module 242 updates the maximum value (S922). If the maximum value is larger than the received sequence number, the maximum value comparing module 242 updates the maximum value (S918) and then requests the retransmission of the lost packet (S920).

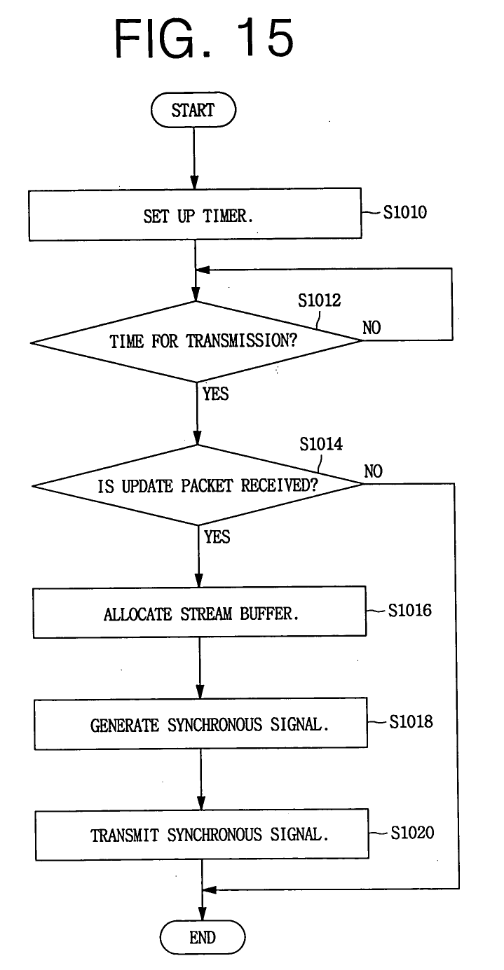

FIG. 15 is a flow chart showing a procedure for sending synchronous signals according to one embodiment of the present invention.

As shown in FIG. 15, the synchronous signal transmitting module 260 operates in accordance with the synchronous signal transmitting timer, and the synchronous signal transmitting timer is set up at the time of initiation (S1010).

The synchronous signal transmitting module 260 determines whether it is time for transmission (S1012) and, if it is, determines whether an update packet has been received (S1014).

If the update packet has been received, the synchronous signal transmitting module 260 allocates a stream buffer (S1016), generates a synchronous signal (S1018), and transmits the generated synchronous signal (S1020).

The receiver buffer management module 222 determines whether it is time to process packets in the receiver buffer 224 and, if so, processes the packets. After that, the receiver buffer management module 222 releases the receiver buffer 224.

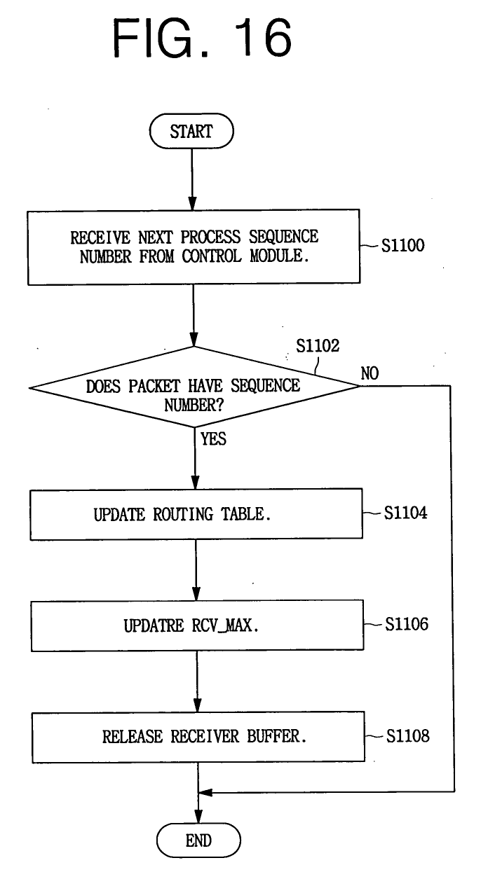

FIG. 16 is a flow chart showing a procedure for managing a receiver buffer according to one embodiment of the present invention.

Referring to FIG. 16, the control module 250b sends an update packet, given that the update packet is in sequence, to RPD for process, and informs the receiver buffer management module 222 of the sequence number of a next packet to be processed (S1100).

The receiver buffer management module 222 compares this sequence number with the present sequence number of a first packet of the receiver buffer 224.

If the two values are equal, the control module 250b updates the routing table (S1104), updates rcv_max (S1106), and releases the receiver buffer 224 (S1108).

In conclusion, the present invention can be advantageously used for reducing overhead when exchanging routing information between routing processors in a distributed router system through TCP.

Moreover, the present invention is beneficial in that it enhances the reliability exchange of routing information between routing processors in a distributed router system, based on the multicasting method.

While the present invention has been particularly shown and described with reference to exemplary embodiments thereof, it will be understood by those skilled in the art that changes in form and detail may be made to the foregoing description without departing from the spirit and scope of the present invention.

1. An apparatus for exchanging routing information in a distributed router system, the apparatus comprising:
an initiating module for performing an initiation process when a routing protocol daemon is operated;
a transceiving unit for allocating a sequence number to update information transmitted from the routing protocol daemon, for adding a header including the allocated sequence number to the update information, for multicasting the update information to a peer, and for receiving a packet from another peer;
a buffer for storing the multicast update information and a non-sequential update packet received from said another peer; and
a control unit responsive to said transceiving unit receiving a sequential update packet from said peer for sending the received sequential update packet and a continuous update packet stored in the buffer to the routing protocol daemon, said control unit being responsive to said transceiving unit receiving the non-sequential packet from said another peer for storing the non-sequential packet in the buffer, said control unit receiving a synchronous signal from said peer and releasing the buffer, receiving a maximum value and requesting retransmission of a lost packet, and transmitting a further synchronous signal and a maximum value periodically, said control unit being responsive to reception of a retransmission request signal from said peer through said transceiving unit for reading the lost packet from said buffer and retransmitting the lost packet through said transceiving unit.

2. The apparatus according to claim 1, wherein said transceiving unit comprises:
a packet transmitting module for allocating the sequence number to the update information transmitted from the routing protocol daemon, for adding the header including the allocated sequence number to the update information, and for multicasting the update information to said peer; and
a packet receiving module for receiving the packet from said another peer, and for transmitting the received packet to said control unit.

3. The apparatus according to claim 1, wherein said buffer comprises:
a sender buffer for storing the multicast update information, the multicast update information being transmitted from said transceiving unit to said peer; and
a receiver buffer for storing the non-sequential update packet, the non-sequential update packet being transmitted from said another peer to said transceiving unit.

4. The apparatus according to claim 1, wherein said control unit comprises:
a buffer management module for receiving the update information with the allocated sequence number from said transceiving unit, and for storing the update information in said buffer, said buffer management module being responsive to the sequential update information being received after storing the non-sequential update packet from said another peer for reading the sequential update packet from said buffer and transmitting the sequential update packet to the routing protocol daemon;
a synchronous signal transmitting module for transmitting a sequential maximum value of the received update packet to said another peer, using a synchronous signal, at a designated transmission time set by a synchronous signal transmitting timer that is set up at an initial time;
a maximum value process module for multicasting a maximum value of the transmitted update information at a designated transmission time set by a maximum value transmitting timer that is set up at initiation, said maximum value process module being responsive to a maximum value being transmitted by said another peer for comparing the multicast maximum value with a maximum value of a present update routing information packet to request the retransmission of the lost packet, and said maximum value process module being responsive to said peer requesting the retransmission of the lost packet for reading the lost packet from said buffer and transmitting the lost packet; and
a control module responsive to synchronous signal being received through the transceiving unit for transmitting the synchronous signal to the buffer management module to release the buffer, said control module being responsive to a maximum value being received through the transceiving unit for transmitting the maximum value to the maximum value process module to be processed, said control module being responsive to a retransmission request signal being received through the transceiving unit for transmitting the retransmission request signal to the maximum value process module to retransmit a packet, said control module being responsive to the transceiving unit receiving a sequential update packet from a peer for transmitting the received sequential update packet and the continuous update packet stored in the buffer to the routing protocol daemon, and said control module being responsive to the transceiving unit receiving a non-sequential update packet from another peer for storing the non-sequential update packet in the buffer.

5. The apparatus according to claim 4, wherein the buffer management module comprises:
a sender buffer management module for receiving the update packet with the allocated sequence number from the transceiving unit and for storing the update packet in the buffer; and
a receiver buffer management module responsive to the sequential update packet being received after storing the non-sequential update packet transmitted from said another peer to the transceiving unit in the buffer for reading the continuous update packet from the buffer and transmitting the continuous update packet to the routing protocol daemon.

6. The apparatus according to claim 4, wherein the maximum value process module comprises:
a maximum value transmitting module for multicasting the maximum value of the transmitted update packet at the designated transmission time set by the maximum value transmitting timer;
a maximum value comparing module for comparing the multicast maximum value with the maximum value of the present update routing information packet so as to request the retransmission of the lost packet when a maximum value is transmitted from said another peer;
a retransmission request module for requesting the retransmission of the lost packet according to a comparison result of the maximum value comparing module; and
a retransmission module responsive to said another peer requesting the retransmission of the lost packet for reading the lost packet from the buffer and retransmitting the lost packet.

7. The apparatus according to claim 6, wherein the retransmission request module sends a retransmission request signal for the lost packet when receiving the non-sequential update packet from said another peer.

8. A method for exchanging routing information in a distributed router, the method comprising the steps of:
performing an initiation process when a routing protocol demon is in operation;
adding a header, including a sequence number, to update information transmitted from the routing protocol daemon, and multicasting the update information to a peer;
transmitting to the routing protocol daemon a sequential update packet provided by another peer and a continuous update packet previously stored;
storing a non-sequential update packet provided by said peer in a receiver buffer;
receiving a synchronous signal from said peer and releasing a sender buffer;
receiving a maximum value and transmitting the maximum value and the synchronous signal periodically; and
reading the lost packet from the sender buffer when a retransmission request signal is received from said peer, and retransmitting the lost packet.

9. The method according to claim 8, wherein the performing step comprises sub-steps of:
allocating a global variable for a routing transceiving structure and initializing contents;
transmitting an activation message to said peer; and
initiating a synchronous signal transmitting timer and a maximum value transmitting timer.

10. The method according to claim 8, wherein the adding step comprises sub-steps of:
allocating a sequence number to the update information when the update information is received from the routing protocol daemon;
multicasting the update packet with the header to said peer after adding the header, including the allocated sequence number, to the update information; and
storing the transmitted update packet in the sender buffer.

11. The method according to claim 8, wherein the transmitting step comprises sub-steps of:
when the sequential update packet is received from said peer, transmitting the received sequential update packet to the routing protocol daemon;
determining whether there is a continuous update packet in the receiver buffer; and
transmitting the continuous update packet to the routing protocol daemon when the continuous update packet is determined to be in the receiver buffer.

12. The method according to claim 8, wherein the step of receiving the synchronous signal comprises sub-steps of:
receiving a plurality of synchronous signals from a plurality of peers;
extracting a least sequence number from the plurality of transmitted synchronous signals; and
deleting an update packet corresponding to the extracted least sequence number and releasing the sender buffer.

13. The method according to claim 8, wherein the step of receiving the maximum value comprises sub-steps of:
receiving the maximum value and requesting the retransmission of the lost packet;
transmitting the synchronous signal periodically; and
transmitting the maximum value periodically.

14. The method according to claim 13, further comprising the step of requesting the retransmission of the lost packet, comprising sub-steps of:
when the maximum value is transmitted, determining whether the maximum value is less than a synchronous signal transmission value;
when the maximum value is less than a synchronous signal transmission value, retransmitting a synchronous signal message;
when the maximum value is greater than a synchronous signal transmission value, determining whether the maximum value is greater than a received sequence number;
when the maximum value is less than the received sequence number, updating the maximum value; and
when the maximum value is greater than the received sequence number, updating the maximum value and requesting retransmission of the lost packet.

15. The method according to claim 13, wherein the step of transmitting the synchronous signal periodically comprises sub-steps of:
determining whether it is a designated time to transmit the synchronous signal;
when it is the designated time to transmit the synchronous signal, determining whether an update packet is received; and
when the update packet is received, allocating a stream buffer, generating the synchronous signal, and transmitting the synchronous signal.

16. The method according to claim 13, wherein the step of transmitting the maximum value periodically comprises sub-steps of:
determining whether it is a designated time to transmit a packet;
when it is the designated time to transmit the packet, determining whether an update packet is transmitted; and
when the update packet is transmitted, transmitting a maximum value transmission message including all sequence numbers of the transmitted update packet.

17. The method according to claim 8, wherein the reading step comprises sub-steps of:
receiving the retransmission request signal from said peer;
confirming whether a requested packet exists; and
when existence of the requested packet is confirmed, reading the requested packet from the sender buffer and transmitting the requested packet.

18. An apparatus for exchanging routing information in a distributed router system, said apparatus comprising:
initiating module means for performing an initiation process when a routing protocol daemon is operated;
transceiving means for allocating a sequence number to update information transmitted from the routing protocol daemon, for adding a header including the allocated sequence number to the update information, for multicasting the update information, and for receiving a packet;
buffer means for storing the multicast update information and a non-sequential update packet received from a peer; and
control means responsive to reception of a sequential update packet for sending the received sequential update packet and a continuous update packet to the routing protocol daemon.

19. The apparatus according to claim 18, said control means being responsive to reception of the non-sequential packet for storing the non-sequential packet in the buffer means.

20. The apparatus according to claim 18, said control means receiving a synchronous signal and a maximum value, and requesting retransmission of a lost packet.

21. The apparatus according to claim 20, said control means transmitting a further synchronous signal and a maximum value periodically.

22. The apparatus according to claim 18, said control means being responsive to reception of a retransmission request signal for reading a lost packet from said buffer means and retransmitting the lost packet through said transceiving means.

23. The apparatus according to claim 18, wherein said transceiving means comprises:
a packet transmitting module for allocating the sequence number to the update information transmitted from the routing protocol daemon, for adding the header including the allocated sequence number to the update information, and for multicasting the update information to said peer; and
a packet receiving module for receiving the packet from another peer, and for transmitting the received packet to said control means.

24. The apparatus according to claim 18, wherein said buffer means comprises:
a sender buffer for storing the multicast update information, the multicast update information being transmitted from said transceiving means to said peer; and
a receiver buffer for storing the non-sequential update packet, the non-sequential update packet being transmitted from said another peer to said transceiving means.

25. The apparatus according to claim 18, wherein said control means comprises:
a buffer management module for receiving the update information with the allocated sequence number from said transceiving means, and for storing the update information in said buffer means, said buffer management module being responsive to the sequential update information being received after storing the non-sequential update packet from said another peer for reading the sequential update packet from said buffer means and transmitting the sequential update packet to the routing protocol daemon;
a synchronous signal transmitting module for transmitting a sequential maximum value of the received update packet to said another peer, using a synchronous signal, at a designated transmission time set by a synchronous signal transmitting timer that is set up at an initial time;
a maximum value process module for multicasting a maximum value of the transmitted update information at a designated transmission time set by a maximum value transmitting timer that is set up at initiation, said maximum value process module being responsive to a maximum value being transmitted by said another peer for comparing the multicast maximum value with a maximum value of a present update routing information packet to request the retransmission of the lost packet, and said maximum value process module being responsive to said peer requesting the retransmission of the lost packet for reading the lost packet from said buffer means and transmitting the lost packet; and
a control module responsive to synchronous signal being received through the transceiving means, for transmitting the synchronous signal to the buffer management module to release the buffer, said control module being responsive to a maximum value being received through the transceiving means for transmitting the maximum value to the maximum value process module to be processed, said control module being responsive to a retransmission request signal being received through the transceiving means for transmitting the retransmission request signal to the maximum value process module to retransmit a packet, said control module being responsive to the transceiving means receiving a sequential update packet from a peer for transmitting the received sequential update packet and the continuous update packet stored in the buffer means to the routing protocol daemon, and said control module being responsive to the transceiving means receiving a non-sequential update packet from another peer for storing the non-sequential update packet in the buffer means.

26. The apparatus according to claim 25, wherein the buffer management module comprises:
a sender buffer management module for receiving the update packet with the allocated sequence number from the transceiving means and for storing the update packet in the buffer means; and
a receiver buffer management module responsive to the sequential update packet being received after storing the non-sequential update packet transmitted from said another peer to the transceiving means in the buffer means for reading the continuous update packet from the buffer means and transmitting the continuous update packet to the routing protocol daemon.

27. The apparatus according to claim 25, wherein the maximum value process module comprises:
a maximum value transmitting module for multicasting the maximum value of the transmitted update packet at the designated transmission time set by the maximum value transmitting timer;
a maximum value comparing module for comparing the multicast maximum value with the maximum value of the present update routing information packet so as to request the retransmission of the lost packet when a maximum value is transmitted from said another peer;
a retransmission request module for requesting the retransmission of the lost packet according to a comparison result of the maximum value comparing module; and
a retransmission module responsive to said another peer requesting the retransmission of the lost packet for reading the lost packet from the buffer and retransmitting the lost packet.

28. The apparatus according to claim 27, wherein the retransmission request module sends a retransmission request signal for the lost packet when receiving the non-sequential update packet from said another peer.
